(19) United States
(12) Patent Application Publication
(10) Pub. No.: US 2018/0001602 A1
(43) Pub. Date: Jan. 4, 2018

(54) Coating of parts or objects and method for obtaining it

(71) Applicant: Emiliano Ferro, Rovolon (PD) (IT)

(72) Inventor: Emiliano Ferro, Rovolon (PD) (IT)

(21) Appl. No.: 15/537,282

(22) PCT Filed: Dec. 19, 2014
(86) PCT No.: PCT/IB2014/067118

§ 371 Date: Jun. 16, 2017

(30) Foreign Application Priority Data
Dec. 18, 2014 (IT) PD2014A000347

(51) Int. Cl. B32B 21/14; B32B 9/00; B32B 9/02; B32B 9/04; B32B 38/00; B29C 45/14; B32B 27/36; B32B 27/12; B32B 37/06; B32B 21/10; B32B 38/04

(52) U.S. Cl. CPC B32B 21/14; B32B 37/06; B32B 9/002; B32B 9/02; B32B 9/045; B32B 9/047; B32B 21/10; B32B 38/0004; B29C 45/14811; B32B 27/365; B32B 27/12; B32B 2038/042; B32B 2250/40; B32B 2307/31; B32B 2451/00; B32B 2605/003; B32B 2605/08

(57) ABSTRACT

A coating of structures or elements or parts made of plastic material obtained by molding includes a finish layer; a reinforcement layer coupled to the finish layer, from the opposite side to the exposed face, to form a sandwich; and a heat-sealable film coupled in its solid form to the reinforcing layer, wherein this sandwich is suited to be coupled to a support part in a plastic material obtained by molding, and wherein this coupling occurs during the molding of the support part by way of the heat-sealable film suited to be activated at the molding temperature.

This patent relates to the coating of plastic parts or objects and in particular relates to a new type of coating of plastic parts or objects, plastic objects or parts at least partially coated, for example, preferably of burl or wood, and the method for obtaining it.

Burl, a fine wood material obtained from the root of some woody plants that have twisted and very compact fibers is a well know material.

Burl, when properly treated, sanded, and polished has an appearance characterized by its grain and is currently used to make quality or ornamental objects, coatings or coating inserts.

Burl is frequently used for interiors of automobiles, particularly luxury automobiles, such as for the coating of parts of the dashboard, console, door panels both front and rear, and so on.

Burl inserts are made of wood veneers, which are placed next to each other and aligned and glued on suitable supports, for example on plastic surfaces. The stability of wood veneers, simply glued to plastic supports, is not guaranteed, especially due to the inevitable and even very small deformations of the wood itself or of the plastic supports in question.

Furthermore, the bonding process is very complex, since it must guarantee the total absence of misalignments.

The prior art also includes coatings, particularly of parts or objects made of plastic, leather, artificial leather, stone or derivatives, fabric, and material in general whether natural or artificial.

These coatings are typically made separately and then coupled to the preformed plastic structure. This coupling takes place with the use of glues or by means of mechanical fasteners, such as staples or stitches. Before or after the coupling, the coating material must also be cut, shaped or deformed to fit on the plastic part on which it must be applied.

The object of the present application is a new type of coating for plastic parts or objects, plastic objects or parts at least partially coated and the method for obtaining it.

The main purpose of this invention is to provide a highly resistant coating, guaranteeing the stability of the coupling between the finish material and the plastic support.

Another purpose is to ensure the durability of the coating, thanks to the innovative coupling method between the finish material and a reinforcement layer.

Yet another purpose of the present invention is to obtain the indirect coupling between the finish material and the plastic support directly during the molding of the plastic support, without any subsequent additional operation.

A further object of the present invention is to have a coating with a quality finish to the eye and touch.

These and other aims, direct and complementary, are achieved by the new coating for plastic parts or objects, plastic objects or parts at least partially coated, for example, preferably of burl or wood, and the method for obtaining it.

The new coating for plastic parts or objects comprises in its main parts at least one finish layer, preferably of quality, with at least one face intended to remain in sight, at least one reinforcement layer directly or indirectly coupled to the finish layer on the side opposite of the exposed face, to form a sandwich, and at least one heat-sealable film, directly or indirectly coupled to at least the reinforcement layer, and wherein this sandwich is suited to be coupled to at least one part of the plastic support of structure, and wherein the coupling occurs during the molding step, by means of the at least one heat-sealable film suited to be activated at the molding temperature.

The plastic object or part or structure or element, at least partially coated obtained in this manner, consists in its main parts of at least one finish layer, preferably of quality, at least one reinforcement layer directly or indirectly coupled to the finish layer to form a sandwich, at least one support part made of plastic material obtained by molding, and wherein the at least one support part is bound at least to the reinforcement layer of the sandwich by means of at least one heat-sealable film, directly or indirectly coupled to at least the reinforcement layer itself and suited to be activated at the molding temperature.

Said at least one finish layer is preferably burl or a wood veneer.

Alternatively, the at least one finish layer can be leather, artificial leather, stone or derivatives, natural or synthetic fabrics, and so on.

Said at least one reinforcement layer is preferably a fabric or other layer made of flexible material suited to be coupled to said at least one finish layer and said at least one heat-sealable film.

The coating obtained is therefore extremely stable, since the finish layer is coupled to the reinforcement layer that prevents or slows down the disintegration or deterioration of the finish material, for example wood or burl, during the subsequent stages of processing, installation, and use of the coating.

The heat-sealable film ensures the lasting and stable coupling between the finish layer, coupled to the reinforcement layer, and the plastic support.

The coating obtained can have any straight or curved shape, provided that the sandwich is adequately curved, molded or shaped in general before its coupling to the support part, as a function of the shape of the support part itself.

The new method for obtaining the coating of the at least one plastic object or part comprises the following steps in its two main parts:
preparation of at least one finish layer, for example, burl or wood, fabric, leather, stone or derivatives, synthetic or natural material;
lamination of the at least one finish layer with at least one reinforcement layer, creating a sandwich obtained by the coupling between the at least one finish layer and the at least one reinforcement layer;
application of said at least one heat-sealable film in its solid form on said at least one reinforcement layer, wherein the application is carried out preferably by means of compression provided by rollers;
shaping and/or contouring in general of the sandwich coupled with said heat-sealable film, wherein the shaping and contouring is a function of the type, size and shape of the coating to be obtained;
insertion of the shaped and contoured sandwich in at least one mold to form at least one support part made of plastic material, with said heat-sealing film facing the inside of the mold;
molding of said at least one support part made of plastic material, and wherein at the molding temperature, said heat-sealable film is activated, ensuring the stable coupling between said sandwich and said plastic support.

The preparation of said at least one finish layer may include various processing and treatment operations on the material used to prepare the finish layer itself.

For example, in the case of a finish layer of burl or wood in general, the application of a primer on all or part of the surface of the wood is required, preferably at least on the non-visible face, suited to ensure the proper and stable coupling of the layer of wood with the reinforcement layer.

The shaping or contouring step comprises, for example, compression provided by rollers and heat treatment, for example steam, of the sandwich to obtain, for example single or multiple curves, curvatures and/or bending of the edges, and deformations in general.

Said shaping step comprises, for example punching or cutting in general of the sandwich, as a function of the coating to be made and the mold in which the sandwich is to be subsequently inserted.

These phases of conformation and shaping in general can be variously combined and inverted.

The molding is preferably of the injection type, and wherein said plastic material is for example polycarbonate and/or PC/ABS and/or ABS, or other plastic material with suitable mechanical, chemical and physical properties. The characteristics of the new plastic object or part at least partially coated and the new method will be better clarified by the following description with reference to the drawing, attached by way of non-limiting example.

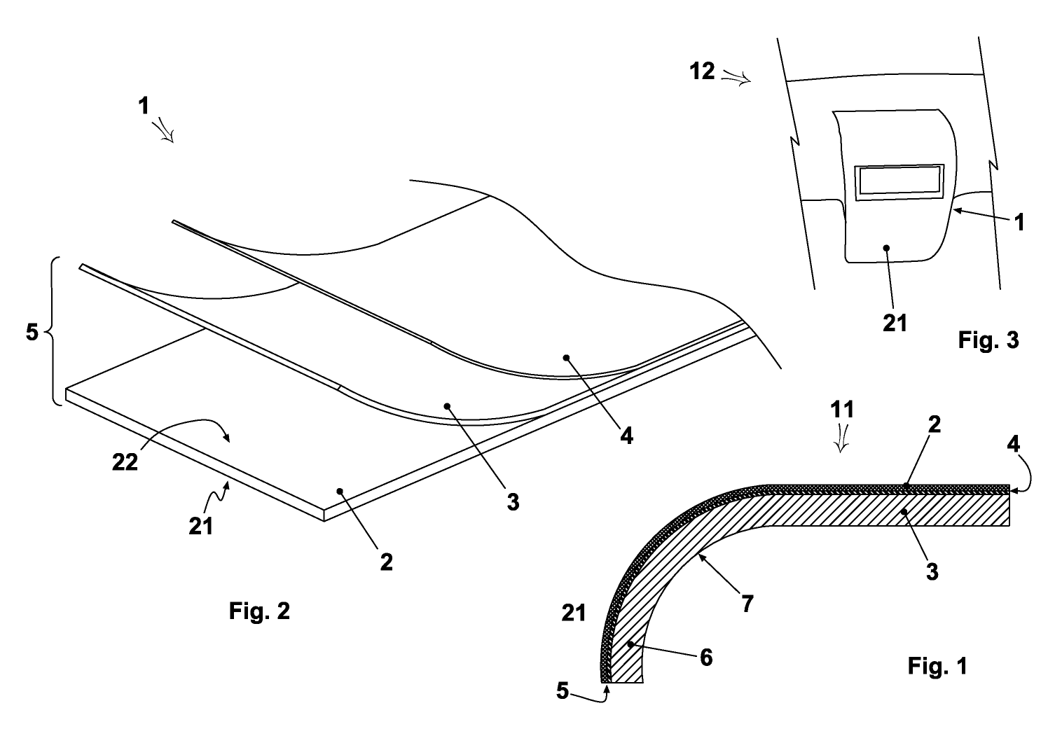

FIG. 1 shows a section of a plastic object or part (11) partially coated, according to an illustrated and exemplified embodiment.

FIG. 2 shows the layering of the new coating (1) comprising the sandwich (5), formed by the coupling of a finish layer (2) and a reinforcement layer (3), with a heat-sealable film (4) applied on the reinforcement layer (3).

FIG. 3 shows schematically, for example, the center console (12) of a vehicle (1), with a coating (1) with a (21) quality finish (21).

The new coating (1) comprises in its main parts at least one finish layer (2) with at least one face (21) intended to remain in view and an opposite face (22) not in view, at least one reinforcement layer (3) directly or indirectly coupled at least to the face (22) opposite the finish layer (2) to form a sandwich (5), and at least one heat-sealable film (4) of the dry type, is in turn coupled with said reinforcement layer (3) of said sandwich (5)

The object (11) in FIG. 1 comprises at least one support part (6) made of plastic material obtained by molding, and where that at least one support part (6) is secured to the reinforcement layer (3) of said sandwich (5) by means of said at least one heat-sealable film (4).

Said heat-sealable film (4) is suited to be activated at the molding temperature, so as to obtain the stable coupling between said sandwich (5) and said support part (6) made of plastic material.

Said coating (1), comprising said sandwich (5) coupled with said heat-sealable film (4), can be variously curved (7) or contoured or shaped in general before its insertion in the mold for the formation of the support part (6), as a function of the shape and dimensions of the mold and as a function of the type, shape and size of the coating (1) to be obtained.

Therefore, with reference to the preceding description and the attached drawing the following claims are made.

The invention claimed is:

1. A coating (1) of structures, elements, or parts (11) made of a plastic material obtained by molding, comprising:
at least one finish layer (2) adapted to be secured to a support part (6) made of a plastic material and produced by molding, said at least one finish layer having at least one exposed face (21) intended to remain visible;
at least one reinforcement layer (3) directly or indirectly coupled to said at least one finish layer (2), at least at an opposite side (22) of said exposed face (21), to form a sandwich (5); and
at least one heat-sealable film (4) directly or indirectly coupled in solid form at least to said at least one reinforcement layer (3),
wherein said sandwich (5) is adapted to be coupled to said at least one support part (6) made of said plastic material, and
wherein said coupling takes place during the molding of said at least one support part (6), by way of said at heat-sealable film (4) activated at a molding temperature.

2. The coating (1) according to claim 1, wherein said at least one finish layer (2) is a sheet of burl wood or a wood veneer.

3. The coating (1) according to claim 1, wherein said at least one finish layer (2) is made of leather, imitation leather, stone or derivatives thereof, or natural or synthetic fabrics.

4. The coating (1) according to claim 1, wherein said at least one reinforcement layer (3) is a fabric or other layer made of a flexible material and adapted to be coupled to said at least one finish layer (2) and said at least one heat-sealable film (4).

5. A structure, element, object or part (11) made of plastic and at least partially coated, comprising:
at least one support part (6) made of a plastic material obtained by molding;
at least one finish layer (2) coupled to said at least one support part (6); and
at least one reinforcement layer (3) directly or indirectly coupled to said finish layer (2) to form a sandwich (5),
wherein said at least one support part (6) is made of the plastic material obtained by molding, and
wherein said at least one support part (6) is bound at least to said at least one reinforcement layer (3) of said sandwich (5) by way of at least one heat-sealable film (4) directly or indirectly coupled at least to said at least one reinforcement layer and configured to be activated at a molding temperature.

6. A process for production of a coating (1) with at least one finish layer (2) on at least one support part (6) made of a plastic material obtained by molding, comprising:
preparing said at least one finish layer (2);
laminating said at least one finish layer (2) with said at least one reinforcement layer (3), producing at least one sandwich (5);
applying at least one heat-sealable film (4) in solid form on at least one reinforcement layer (3);
inserting said sandwich (5) coupled to said heat-sealable film (4) in at least one mold to form said at least one support part (6) made of the plastic material, with said heat-sealable film (4) facing an interior of the mold; and
molding said at least one support part (6) made of the plastic material,
wherein at a molding temperature, said heat-sealable film (4) is activated, ensuring a stable coupling between said sandwich (5) and said at least one support part (6) made of the plastic material.

7. The method, according to claim 6, further comprising at least one conformation and/or shaping step of said sandwich (5) coupled to said heat-sealable film (4) before insertion in said mold, wherein said conformation and shaping is a function of type, size, and shape of the coating (1) to be obtained and the mold.

8. The method, according to claim 7, wherein said shaping step comprises a compression provided by rollers and/or a heat treatment of said sandwich (5) coupled or not coupled to said heat-sealable film (4) to form single or multiple curves, curvatures, and/or bending of edges, and deformations.

9. The method, according to claim 7, wherein said shaping step comprises punching or cutting of said sandwich (5) coupled or not coupled to said heat-sealable film (4).

10. The method, according to claim 6, wherein said molding step comprises injecting, and wherein said plastic material is a polycarbonate, PC/ABS, ABS, or a combination thereof having predetermined mechanical, chemical, and physical characteristics.
